(19) United States
(12) Patent Application Publication
(10) Pub. No.: US 2019/0347057 A1
(43) Pub. Date: Nov. 14, 2019

(54) IMAGE FORMING APPARATUS SETTING PRINTING CONDITION AND NUMBER OF RECORDING PAPER SHEETS

(71) Applicant: KYOCERA Document Solutions Inc., Osaka (JP)

(72) Inventors: Nixon SEGARRA, Jr., Osaka (JP); Deniel MOLINA, Osaka (JP); Jesus Jovannie John BURGOS, Osaka (JP); Rodney OMANGAYON, Osaka (JP); Shiela Mae QUIMBO, Osaka (JP); Vinald Rey CAGATAN, Osaka (JP); Jefty NEGAPATAN, Osaka (JP); John Mathew CABIDO, Osaka (JP)

(73) Assignee: KYOCERA Document Solutions Inc., Osaka (JP)

(21) Appl. No.: 16/395,572

(22) Filed: Apr. 26, 2019

(30) Foreign Application Priority Data
May 11, 2018 (JP) 2018-092532

(51) Int. Cl. G06F 3/12; G06F 3/0488; H04N 1/00

(52) U.S. Cl. CPC G06F 3/1258; G06F 3/1204; H04N 1/00411; H04N 1/00392; G06F 3/04883

(57) ABSTRACT

An image forming apparatus includes: an image forming unit that forms an image on a recording paper sheet; a storage unit; a display; a touch panel provided on a screen of the display; and a control unit including a processor. When the processor executes a control program, the control unit functions as: a recognition section that, upon performance of a slide gesture on the touch panel, recognizes a number represented by the slide gesture detected by the touch panel and determines a size of the number; and a control section that sets, among a plurality of printing conditions previously stored in the storage unit, a printing condition corresponding to the size of the number determined by the recognition section and allows the image forming unit to form an image under the set printing condition on the same number of recording paper sheets as indicated by the recognized number.

### INCORPORATION BY REFERENCE

This application claims priority to Japanese Patent Application No. 2018-092532 filed on 11 May 2018, the entire contents of which are incorporated by reference herein.

### BACKGROUND

The present disclosure relates to image forming apparatuses including a display and a touch panel provided on a screen of the display, and particularly relates to a technique for setting a printing condition of an image and another or other conditions by a gesture on the touch panel.

There is known an image forming apparatus in which the names of functions and respective pieces of function identification information are previously stored in association with each other in a database and, upon input of the name of a function by gestures on a touch panel, a piece of function identification information associated with this name of the function is identified among those in the database and a display is allowed to display setting buttons or the like for setting of the function according to the identified piece of function identification information and a display rule.

Furthermore, there is known an apparatus in which combinations of guidance message and function button are displayed on a touch sensor-equipped display panel and, upon a user's input of a special character, such as “o” or “×”, in handwriting as a response to any guidance message, a function to be executed is selected according to the input special character.

### SUMMARY

A technique improved over the aforementioned techniques is proposed as one aspect of the present disclosure.

An image forming apparatus according to an aspect of the present disclosure includes an image forming unit, a storage unit, a display, a touch panel, and a control unit. The image forming unit forms an image on a recording paper sheet. The touch panel is provided on a screen of the display. The control unit includes a processor. When the processor executes a control program, the control unit functions as a recognition section and a control section. Upon performance of a slide gesture on the touch panel, the recognition section recognizes a number represented by the slide gesture detected by the touch panel and determines a size of the number. The control section sets, among a plurality of printing conditions previously stored in the storage unit, a printing condition corresponding to the size of the number determined by the recognition section and allows the image forming unit to form an image under the set printing condition on the same number of recording paper sheets as indicated by the number recognized by the recognition section.

### BRIEF DESCRIPTION OF THE DRAWINGS

FIG. 1 is a cross-sectional view showing an image forming apparatus according to an embodiment of the present disclosure.

FIG. 2 is a block diagram showing an essential internal configuration of the image forming apparatus according to the embodiment.

FIG. 3 is a view showing a small region, middle regions, and distal regions of a screen of a display of the image forming apparatus.

FIG. 4A is a view showing the relationship between the distal regions of the screen of the display and the size of a number.

FIG. 4B is a view showing the relationship between the middle regions of the screen of the display and the size of a number.

FIG. 4C is a view showing the relationship between the small region of the screen of the display and the size of a number.

FIG. 5 is a flowchart showing processing procedures for setting a printing condition corresponding to the size of a number drawn on the screen of the display by a slide gesture on a touch panel and a number of recording paper sheets to be printed corresponding to the drawn number.

FIG. 6 is a view illustrating a situation where lines not representing a number are drawn on the screen of the display.

FIG. 7 is a view illustrating a confirmation message displayed on the screen of the display.

FIG. 8 is a view illustrating a situation where a number is drawn within a marginal region of the screen of the display.

### DETAILED DESCRIPTION

Hereinafter, a description will be given of embodiments of the present disclosure with reference to the drawings.

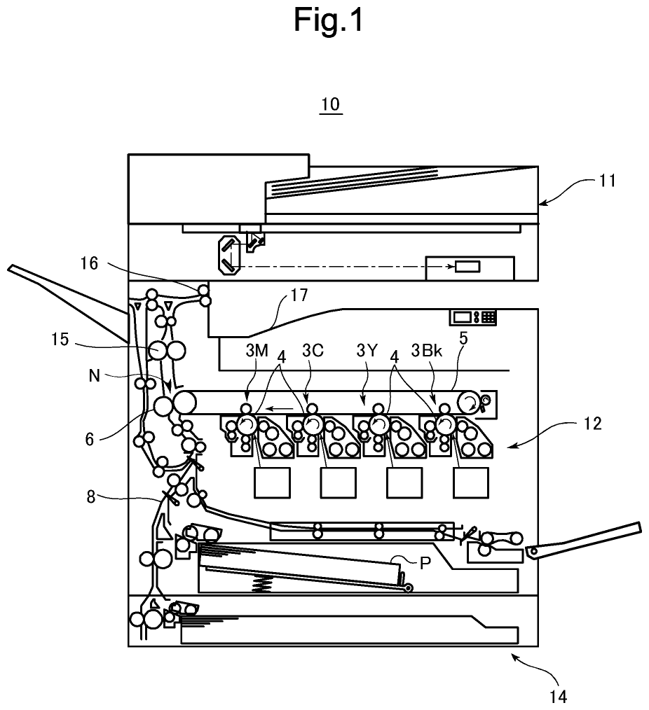

FIG. 1 is a cross-sectional view showing an image forming apparatus according to an embodiment of the present disclosure. An image forming apparatus 10 according to this embodiment is, for example, a multifunction peripheral having multiple functions, including a copy function, a print function, and a scan function. The image forming apparatus 10 includes an image reading unit 11 and an image forming unit 12.

The image reading unit 11 includes an image pickup device capable of optically reading an image of an original document. An analog output of this image pickup device is converted to a digital signal, so that image data representing the image of the original document is generated.

The image forming unit 12 is a section that prints on a recording paper sheet the image represented by the image data and includes an image forming unit 3M for magenta, an image forming unit 3C for cyan, an image forming unit 3Y for yellow, and an image forming unit 3Bk for black. Each of these image forming units 3M, 3C, 3Y, and 3Bk uniformly charges the surface of a photosensitive drum 4, exposes the surface of the photosensitive drum 4 to light to form an electrostatic latent image on the surface of the photosensitive drum 4, develops the electrostatic latent image on the surface of the photosensitive drum 4 into a toner image, and primarily transfers the toner image on the surface of the photosensitive drum 4 to an intermediate transfer belt 5. Thus, a multicolor toner image is formed on the intermediate transfer belt 5. This multicolor toner image is secondarily transferred, at a nip region N between the intermediate transfer belt 5 and a secondary transfer roller 6, to a recording paper sheet P conveyed from a sheet feed section 14 via a conveyance path 8.

Thereafter, heat and pressure are applied to the recording paper sheet P by a fixing device 15, so that the toner image on the recording paper sheet P is fixed by heat and pressure. Then, the recording paper sheet P is discharged through an ejection roller 16 to a sheet output tray 17.

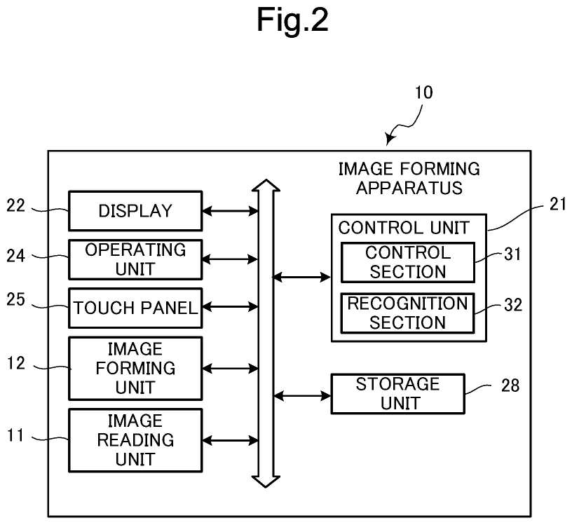

Next, a description will be given of a configuration related to the control of the image forming apparatus 10. FIG. 2 is a functional block diagram showing an essential internal configuration of the image forming apparatus 10. As shown in FIG. 2, the image forming apparatus 10 includes a control unit 21, a display 22, an operating unit 24, a touch panel 25, a storage unit 28, the image reading unit 11, the image forming unit 12, and so on. These components can transfer data or signals to and from one another via a bus.

The display 22 is formed of a liquid crystal display (LCD), an organic EL (OLED: Organic Light-Emitting Diode) display or the like.

The operating unit 24 includes hard keys, including numeric keys, an Enter key, and a Start key.

A touch panel 25 is provided over the screen of the display 22. The touch panel 25 is a touch panel of a so-called resistive film system, a capacitance system or any other system, detects a touch on the touch panel 25 with a user's finger or the like, together with a point of touch, and thus allows a user's instruction for a graphical user interface (GUI) or the like on the screen of the display 22 to be input through the touch panel 25. Therefore, the touch panel 25 serves as an operating unit through which a user's operation by gesture toward the screen of the display 22 is to be input.

The storage unit 28 is formed of a RAM (Random Access Memory), a large-capacity HDD (Hard Disk Drive) and the like and stores various types of data and programs.

The control unit 21 is composed of a processor, a RAM, a ROM (Read Only Memory), and so on. The processor is a CPU (Central Processing Unit), an MPU (Micro-Processing Unit), an ASIC (Application Specific Integrated Circuit) or the like. When a control program stored in the above ROM or the storage unit 28 is executed by the above processor, the control unit 21 functions as a control section 31 and a recognition section 32. Alternatively, each of the control section 31 and the recognition section 32 may not be implemented by the operation in accordance with the control program but may be constituted by a hardware circuit.

The control section 31 serves as a processing section that executes various types of processing. The control section 31 controls the display 22 to display various types of setting screens, various types of information or so on.

When a slide gesture toward the screen of the display 22 is performed by a slide gesture on the touch panel 25, the recognition section 32 recognizes a number represented by the slide gesture detected by the touch panel 25 and determines the size of the number.

In the image forming apparatus 10 according to this embodiment, when a user operates the operating unit 24 or the touch panel 25 to issue an instruction to execute a print job, the control section 31 allows the image reading unit 11 to read an image of an original document and input image data representing the image of the original document to the image forming unit 12 and allows the image forming unit 12 to print the image of the original document on a recording paper sheet or sheets.

Instead, when, prior to the execution of the above print job, the user draws a number on the screen of the display 22 by a slide gesture on the touch panel 25, the recognition section 32 recognizes the number represented by the slide gesture through the touch panel 25 and determines the size of the number. The control section 31 sets, among a plurality of predetermined printing conditions, a printing condition corresponding to the size of the number determined by the recognition section 32 and allows the image forming unit 12 to form an image under the above set printing condition on the same number of recording paper sheets as indicated by the number recognized by the recognition section 32.

For example, the recognition section 32 detects through the touch panel 25 a line drawn on the screen of the display 22 by a slide gesture (a trace drawn by a sequence of slide gesture) and recognizes a number represented by the line by an OCR (Optical Character Recognition) function.

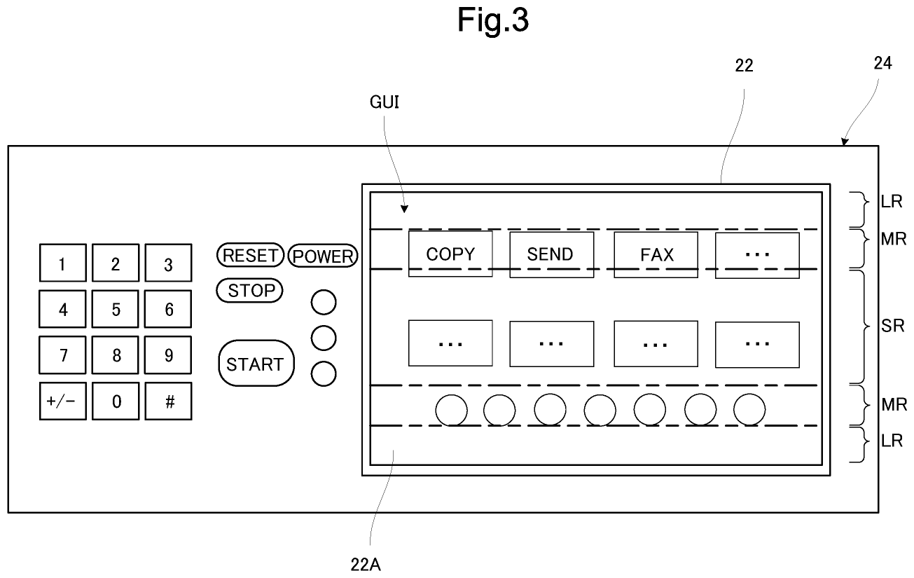

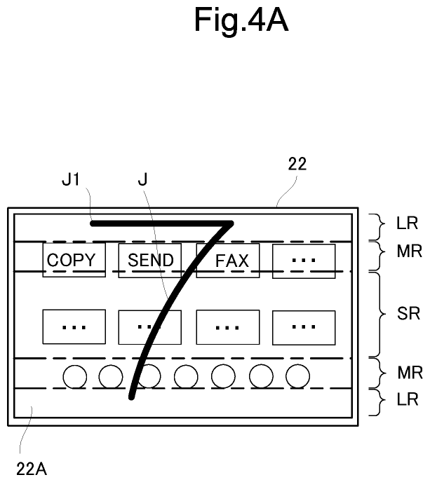

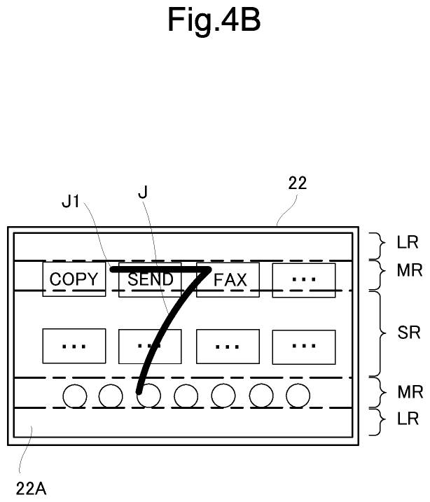

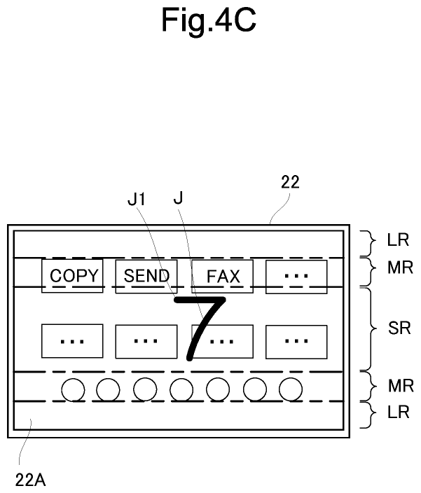

Furthermore, the recognition section 32 detects through the touch panel 25 a starting point of the line on the screen of the display 22 and determines the size of the number based on the starting point of the line. In this relation, as shown in FIG. 3, the screen 22A of the display 22 is divided into a small region SR, respective middle regions MR adjacent to the top and bottom of the small region SR, and respective distal regions LR adjacent to the top of the one middle region MR and the bottom of the other middle region MR. For example, when, as shown in FIG. 4A, a number “7” is drawn on the screen 22A of the display 22 so that a starting point J1 of a line J representing the number “7” falls within the one distal region LR, the recognition section 32 determines the size of the number “7” to be a large size. For another example, if, as shown in FIG. 4B, the starting point J1 of the line J representing the number “7” falls within the one middle region MR, the recognition section 32 determines the size of the number “7” to be a middle size. For still another example, if, as shown in FIG. 4C, the starting point J1 of the line J representing the number “7” falls within the small region SR, the recognition section 32 determines the size of the number “7” to be a small size.

Then, the control section 31 sets, among the plurality of printing conditions previously stored in the storage unit 28, a printing condition corresponding to the large, middle or small size of the number determined by the recognition section 32 and allows the image forming unit 12 to form an image under the above set printing condition on the number of recording paper sheets corresponding to the recognized number. The printing condition includes, for example, resolution and sharpness. For example, when the number is of the large size, the control section 31 sets high resolution and high sharpness as the printing condition. When the number is of the middle size, the control section 31 sets middle resolution and middle sharpness as the printing condition. When the number is of the small size, the control section 31 sets low resolution and low sharpness as the printing condition.

Instead of, as described above, the determination of the size of a number based on whether a starting point of a line drawn by a slide gesture falls within the small region SR, the middle region MR or the distal region LR, the recognition section 32 may determine the size of the number formed of the line based on (i) whether an end point of the line drawn by the slide gesture falls within the small region SR, the middle region MR or the distal region LR or (ii) whether both the starting and end points of the line fall within the small region SR, the middle regions MR or the distal regions LR. The control section 31 may set contrast, density, and/or hue as the printing condition.

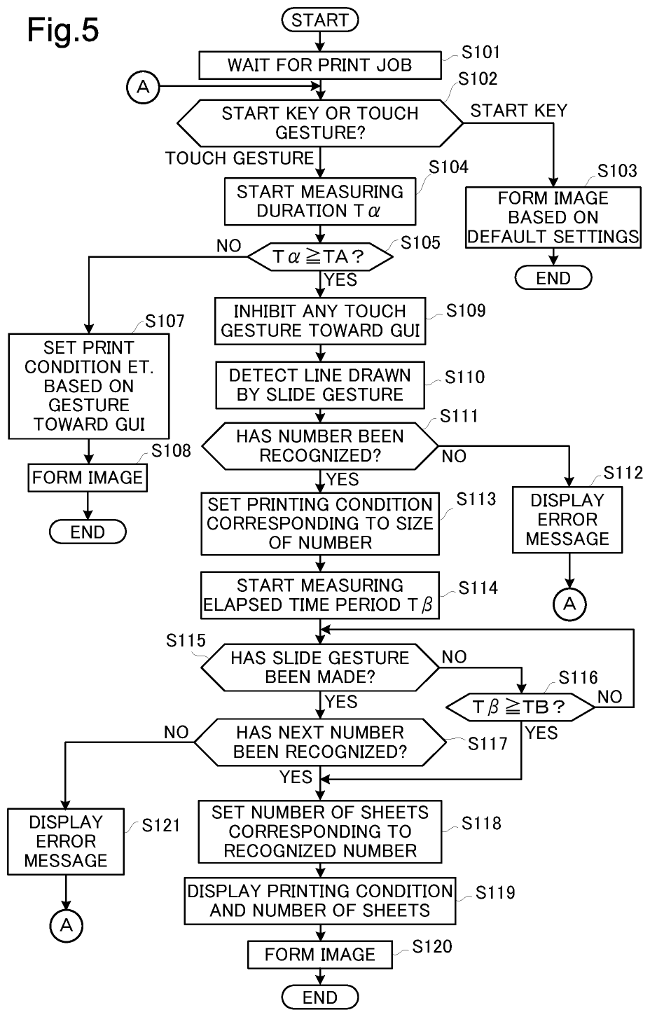

Next, a description will be given of processing procedures for setting, in preparation for execution of a print job, a printing condition corresponding to the size of a number drawn on the screen of the display 22 by a slide gesture on the touch panel 25 and a number of recording paper sheets to be printed corresponding to the drawn number, with reference to the flowchart shown in FIG. 5 and other figures.

First, the control section 31 waits for the execution of a print job (step S101). At this time, when the user operates the Start key of the operating unit 24 to input an instruction to execute a copy operation (“Start Key” in step S102), the control section 31 allows the image reading unit 11 to read an image of an original document, inputs image data representing the image of the original document to the image forming unit 12, and allows the image forming unit 12 to print the image on a single recording paper sheet under a default printing condition (step S103).

Instead, when the user makes a touch gesture on the touch panel 25 (“Touch Gesture” in step S102), the control section 31 starts measuring the duration Tα of the touch gesture with a timer incorporated in the control unit 21 (step S104). When the touch gesture terminates before the duration Tα reaches a fixed time TA (NO in step S105), the control section 31 determines the touch gesture to be a touch gesture toward a GUI being displayed on the screen of the display 22 (toward various buttons being displayed for accepting an instruction from the user) and sets the printing condition, the number of recording paper sheets to be printed, and so on corresponding to the GUI toward which the touch gesture has been made (step S107). Then, when the user operates the Start key, the control section 31 allows the image reading unit 11 to read an image of an original document and allows the image forming unit 12 to print the image of the original document under the set printing condition and on the set number of recording paper sheets (step S108).

On the other hand, when the duration Tα of the touch gesture reaches the fixed time TA (YES in step S105), the control section 31 inhibits any touch gesture toward the GUI (step S109). In other words, when the touch gesture on the touch panel 25 is continued for the predetermined time period, the control section 31 avoids accepting any input of an instruction based on a gesture toward the GUI being displayed on the screen of the display 22. And the control section 31 starts processing for setting a printing condition corresponding to the size of a number to be drawn on the screen of the display 22 by a slide gesture in the manner previously described and a number of recording paper sheets to be printed corresponding to the drawn number.

In summary, when making a touch gesture on the touch panel 25 within less than the fixed time TA, the user can set a printing condition or other conditions based on the gesture toward the GUI. On the other hand, when continuing a touch gesture on the touch panel 25 for the fixed time TA or more without changing the point of the touch gesture, the user can subsequently set a printing condition and so on based on a number drawn on the screen of the display 22.

In the latter case, when the user draws a number on the screen of the display 22 by a slide gesture on the touch panel 25 after the duration Tα of the touch gesture reaches the fixed time TA, the recognition section 32 detects, through the touch panel 25, a line drawn on the screen of the display 22 by the slide gesture and recognizes the number represented by the line by the OCR function (step S110).

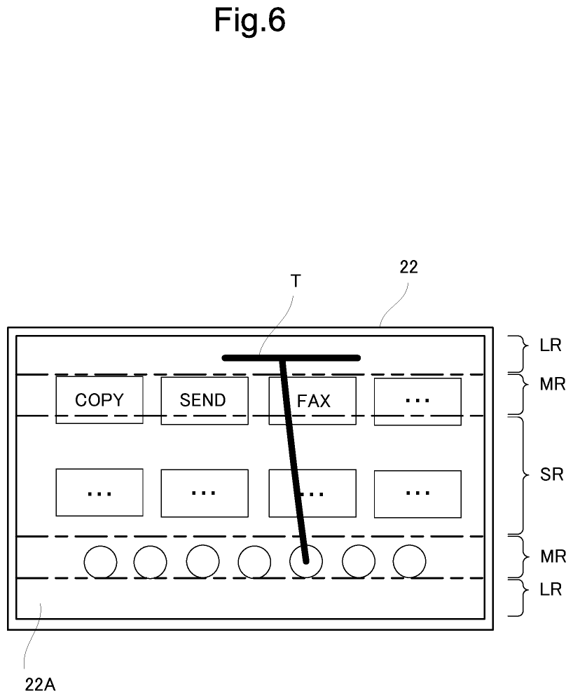

In doing so, when the recognition section 32 fails to recognize the number (NO in step S111), the control section 31 allows the display 22 to display an error message indicating a failure to recognize the number (step S112). Then, the processing goes back to step S102. For example, if a character different from numbers or a sign T is drawn on the screen 22A of the display 22 as shown in FIG. 6, the recognition section 32 fails to recognize the character or sign as a number and, therefore, the control section 31 allows the display 22 to display the error message.

On the other hand, when the recognition section 32 succeeds in recognizing the number (YES in step S111), the recognition section 32 determines the size of the number, depending on whether the starting point of the line representing the recognized number falls within the small region SR, the middle region MR or the distal region LR, based on the coordinates of the line acquired by the touch panel 25 from the user's slide gesture made toward the screen of the display 22. The recognition section 32 sets a printing condition corresponding to the determined size of the number (step S113).

The control section 31 starts measuring the elapsed time period Tβ from when the number has been recognized by the recognition section 32 in the above manner (step S114) and waits for an additional input of a further slide gesture through the touch panel 25 (step S115, NO in step S115, and NO in step S116).

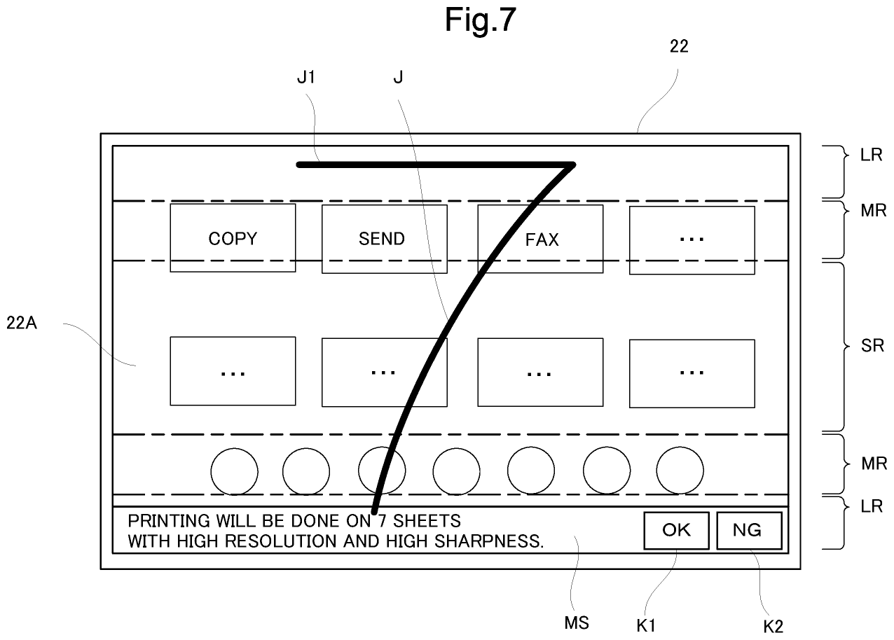

When the user has not drawn a next number on the screen of the display 22 by a further slide gesture on the touch panel 25 before the elapsed time period Tβ reaches a prescribed time TB, i.e., when the recognition section 32 has not accepted an additional input of a further slide gesture through the touch panel 25 (NO in step S115) and the control section 31 determines that the elapsed time period Tβ has reached the prescribed time TB (YES in step S116), the control section 31 sets a number of recording paper sheets to be printed corresponding to the number (a single digit in this case) recognized in steps S110 and S111 (step S118). Furthermore, as shown as an example in FIG. 7, the control section 31 allows the display 22 to display a confirmation message MS indicating the printing condition set in step S113 and the number of recording paper sheets set in step S118 (step S119).

The user confirms the printing condition and the number of recording paper sheets both displayed on the display 22 and then makes a touch gesture toward an OK key K1 or an NG key K2 displayed on the screen of the display 22. For example, when accepting an input of a touch gesture toward the OK key K1 through the touch panel 25, the control section 31 controls the image forming unit 12 to record an image, under the printing condition set in step S113, on the number of recording paper sheets set in step S118 (step S120).

On the other hand, when the user has drawn a next number on the screen of the display 22 by a further slide gesture on the touch panel 25 before the elapsed time period Tβ reaches the prescribed time TB, and the recognition section 32 has accepted an additional input of the further slide gesture through the touch panel 25 (NO in step S116 and YES in step S115), the recognition section 32 detects a line drawn by the further slide gesture through the touch panel 25 and recognizes the number represented by the line by the OCR function (step S117). When the recognition section 32 succeeds in recognizing the number represented by the line (YES in step S117), it determines a number formed of a plurality of digits (two digits in this embodiment) including the number recognized in steps S110 and S111 as a higher order digit and the number recognized in step S117 as a lower order digit. The control section 31 sets a number of recording paper sheets to be printed corresponding to the determined number formed of the plurality of digits (step S118) and, as shown as an example in FIG. 7, allows the display 22 to display a confirmation message MS indicating the printing condition set in step S113 and the number of recording paper sheets set in step S118 (step S119).

Furthermore, when determining that a touch gesture toward the OK key K1 has been made through the touch panel 25, the control section 31 accepts an instruction to execute the formation of an image and controls the image forming unit 12 to form the image on the number of recording paper sheets set in step S118 under the printing condition set in step S113 (step S120). On the other hand, when the user makes a touch gesture toward the NG key K2 and the control section 31 thus accepts an instruction to cancel the formation of an image, the processing goes back to step S102.

When the recognition section 32 fails to recognize by OCR a number formed of a line drawn on the screen of the display 22 based on the above further slide gesture (NO in step S117), the control section 31 allows the display 22 to display an error message indicating a failure to recognize the number (step S121). Then, the processing goes back to step S102.

In the general techniques previously described, the display of setting buttons or the selection of a function corresponding to the name of a function or a special character input by a gesture on a touch panel or a touch sensor, respectively, is performed. However, in order to input a more detailed setting, it is necessary to input a further instruction based on a setting button or make a further gesture for inputting setting on the function. Such an input operation is troublesome.

Unlike the above, in this embodiment, when the user draws a number on the screen of the display 22, an image can be formed under a printing condition corresponding to the size of the number and on a number of recording paper sheets corresponding to the number. In other words, both the printing condition for an image and the number of recording paper sheets on which the image is to be formed can be specified with a single input gesture on the touch panel 25.

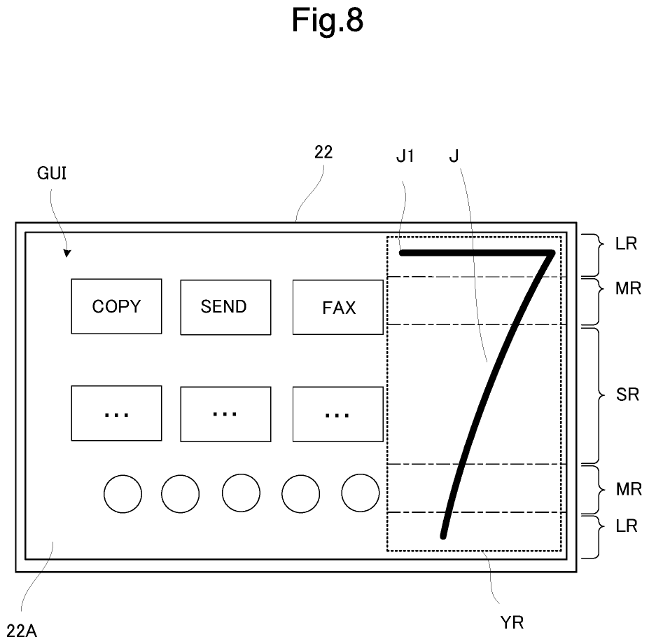

In the above embodiment, when a touch gesture on the touch panel 25 is continued for the predetermined time period, the recognition section 32 performs the recognition of a number drawn on the whole screen of the display 22 by a slide gesture following the touch gesture and the determination of the size of the number. Alternatively, as shown as an example in FIG. 8, a number may be drawn by a slide gesture within a marginal region YR of the screen of the display 22 (a blank region of the display screen) and the recognition section 32 may perform the recognition of the number drawn within the marginal region YR and the determination of the size of the number. Furthermore, when an additional number is drawn within the marginal region YR by a further slide gesture on the touch panel 25 a prescribed time after the previous number is drawn within the marginal region YR, the recognition section 32 may determine a multi-digit number formed of the previous number and the additional number. In this embodiment, since a number drawn within the marginal region YR by a slide gesture is recognized, the recognition of the number has no effect on the acceptance of a user's instruction based on the GUI being displayed on the screen of the display 22 and, therefore, the control section 31 can always accept an input of an instruction based on a gesture toward the GUI being displayed on the screen of the display 22.

As shown in FIG. 3, the control section 31 may allow the display 22 to display, on the screen, boundaries (dash-dot lines) between the small region SR and each middle region MR and boundaries (dash-double-dot lines) between each middle region MR and the adjacent distal region LR. Alternatively, the control section 31 may make the small region DR, the middle region MR, and the distal region LR different from each other in the density, lightness, color or other visual characteristics of their background and allow the display 22 to display these different regions in different display manners. Thus, the user can make each of slide gestures for large-sized, middle-sized, and small-sized numbers on the screen of the display 22 readily distinguishably from the other two slide gestures.

Alternatively, when the user makes a slide gesture, the recognition section 32 may detect, through the touch panel 25, a line drawn on the screen of the display 22 by the slide gesture, further detect the length or breadth of a number represented by the line, and determine the size of the number according to the length or breadth.

The size of the number determined by the recognition section 32 are not limited to include the above three sizes (large, middle, small) and may include two sizes or four or more sizes. In these cases, the control section 31 sets one of different printing conditions corresponding to the above different sizes.

The structures, configurations, and processing in the above embodiments described with reference to FIGS. 1 to 8 are merely examples of the present disclosure and the present disclosure is not intended to be limited to the above structures, configurations, and processing.

While the present disclosure has been described in detail with reference to the embodiments thereof, it would be apparent to those skilled in the art the various changes and modifications may be made therein within the scope defined by the appended claims.

What is claimed is:

1. An image forming apparatus comprising:
an image forming unit that forms an image on a recording paper sheet;
a storage unit;
a display;
a touch panel provided on a screen of the display; and
a control unit comprising a processor and, when the processor executes a control program, functioning as:
a recognition section that, upon performance of a slide gesture on the touch panel, recognizes a number represented by the slide gesture detected by the touch panel and determines a size of the number; and
a control section that sets, among a plurality of printing conditions previously stored in the storage unit, a printing condition corresponding to the size of the number determined by the recognition section and allows the image forming unit to form an image under the set printing condition on the same number of recording paper sheets as indicated by the number recognized by the recognition section.

2. The image forming apparatus according to claim 1, wherein when a touch gesture on the touch panel is continued for a predetermined time period, the recognition section recognizes the number drawn on the screen of the display by the slide gesture following the touch gesture and determines the size of the number.

3. The image forming apparatus according to claim 1, wherein when the slide gesture on the touch panel is made within a marginal region of the screen of the display, the recognition section recognizes the number represented by the slide gesture and determines the size of the number.

4. The image forming apparatus according to claim 2, wherein
when, before elapse of a prescribed time since the slide gesture on the touch panel has been made, a further slide gesture is made, the recognition section recognizes respective numbers represented by the slide gesture made previously and the further slide gesture and determines a multi-digit number including the number represented by the previous slide gesture as a higher order digit and the number represented by the further slide gesture as a lower order digit, and
the control section allows the image forming unit to form an image on the same number of recording paper sheets as indicated by the determined multi-digit number.

5. The image forming apparatus according to claim 2, wherein when the touch gesture on the touch panel is continued for the predetermined time period, the control section avoids accepting any input of an instruction based on a gesture toward a graphical user interface being displayed on the screen of the display.

6. The image forming apparatus according to claim 1, wherein
the screen of the display is divided into respective different regions corresponding to a plurality of sizes of the number, and
the recognition section determines a size corresponding to, among the different regions, one region containing a starting point or an end point of the slide gesture made on the screen of the display as the size of the number represented by the slide gesture.

7. The image forming apparatus according to claim 6, wherein the control section allows the display to display the different regions of the screen in different display manners.

8. The image forming apparatus according to claim 1, wherein the control section allows the display to display a confirmation message indicating the printing condition corresponding to the size of the number and the number of recording paper sheets corresponding to the recognized number.

9. The image forming apparatus according to claim 5, wherein when the touch gesture on the touch panel terminates before elapse of the predetermined time period, the control section accepts an input of an instruction based on the touch gesture toward the graphical user interface being displayed on the screen of the display.

10. The image forming apparatus according to claim 6, wherein the control section allows the display to display boundaries between the different regions of the screen.

11. The image forming apparatus according to claim 1, wherein
the storage unit previously stores respective printing conditions corresponding to a plurality of sizes of the number, and
each of the printing conditions includes at least a resolution.
